(19) United States
(12) Patent Application Publication
(10) Pub. No.: US 2016/0363605 A1
(43) Pub. Date: Dec. 15, 2016

(54) SELF-OPERATING AND TRANSPORTABLE REMOTE LAB SYSTEM

(71) Applicant: MeasureMeNow, Inc., Spring Park, MN (US)

(72) Inventor: Lars Liepold, Spring Park, MN (US)

(21) Appl. No.: 15/178,784

(22) Filed: Jun. 10, 2016

Related U.S. Application Data
(60) Provisional application No. 62/174,146, filed on Jun. 11, 2015.

(51) Int. Cl. G01N 35/00; B01L 1/00; F24F 3/16; G06F 19/00

(52) U.S. Cl. CPC G01N 35/00871; G06F 19/366; G01N 35/0099; B01L 1/00; G01N 35/00732; G01N 35/00623; F24F 3/161; G01N 2035/00881; B01L 2200/185; G01N 2035/00831; G01N 2035/00653

(57) ABSTRACT

Methods and systems for transportable self-operating lab system units are disclosed. In certain implementations, the lab system may be contained within a shipping container configured to be modular or otherwise cooperate with each other or another system. The units may be configured to be readily transportable and configured to be set up in various locations. Additionally, a unit may be configured to utilize robotic systems to enable the unit to receive and analyze specimens without the need for support personnel to be present. The unit may be configured to be managed remotely and request local assistance as needed. The system may be configured to obviate the need for highly-trained personnel, expensive equipment, costly maintenance and instruments running near capacity to offset cost, thereby making the most advanced analytical methodologies available to small, non-research communities.

### CROSS-REFERENCE TO RELATED APPLICATIONS

This application claims the benefit under 35 U.S.C. §119 of the earlier filing date of U.S. Provisional Application No. 62/174,146, filed Jun. 11, 2015, entitled “Self-Operating Remote Lab System,” which is hereby fully incorporated by reference for any and all purposes as if fully set forth herein in its entirety.

Embodiments described in this application may be used in combination or conjunction with the subject matter described in U.S. Patent Publication Number 2014/0276217, entitled “Fluid Sampling Apparatus and Method,” which is hereby fully incorporated by reference for any and all purposes as if set forth herein in its entirety.

### FIELD

The present disclosure relates generally to methods and systems for improving remote lab systems.

BACKGROUND

Despite the need for improved diagnostics in healthcare, many advanced analytical methodologies commonly used in research settings are not utilized as diagnostic solutions in clinical settings. This is the case as numerous barriers exist when bringing high-performance tests to non-research (e.g., non-academic, non-pharmaceutical) settings. These barriers include: the need for highly-trained personnel, expensive equipment, costly maintenance, specialized laboratory facilities, and instruments running near capacity to offset cost. Furthermore that lack of automation and standardization, in the context of advanced complex laboratory processes, can result in inconsistent results. In addition, the physical distance between specimen collection and specimen analysis results in specimen transportation times on the order of days. This transportation time adds an undesirable lag-time between specimen collection and specimen analysis results being available. There exists a need in the art to overcome these and other limitations of traditional systems.

Furthermore, these traditional analysis systems often require laboratory personnel to perform routine and semi-routine tasks that aid in the analysis of specimens. These tasks typically fall into three categories: 1) transporting samples to and from various areas of a laboratory and between various laboratory equipment, 2) performing semi-routine tasks to maintain laboratory equipment in a desired operational state and 3) programming or controlling laboratory equipment through a computer program to perform tasks. Because task-category 3 is typically performed through a computer workstation, these tasks can be performed via a remote workstation located outside the lab. Task-categories 1 and 2 are often performed within the interior of the laboratory.

Task-categories 1 and 2 are often highly repetitive. For example, it is common to have two primary equipment platforms in the analysis of a specimen. The first primary equipment platform used in the process to analyze a sample is a specimen preparation robot. This specimen-preparation-robot accepts the sample in a raw state (e.g., a blood sample) and then processes that sample so that it is in an acceptable state for analysis. The second primary equipment platform is the analysis-equipment used to analyze the prepared sample. Given the existence and common use of specimen-preparation-robots, laboratory personnel are left with tasks related to transporting the specimen to and from these two primary equipment platforms. The lack of automation results in laboratory personnel introducing inconsistencies into these tasks that might result in less than desirable outcomes in the analysis results. Also, laboratory personnel add cost to the overall analysis. There exists a need to create systems that address the shortcomings of non-automated tasks that are traditionally carried out by laboratory personnel.

There also exists a need to shorten the time between specimen collection and specimen analysis for all types of analyses. Information from analyses can provide more solutions to end users as the lag-time between sample collection and sample results decreases. For example, an emergency room doctor seeking a particular, non-typical analysis would find utility if the analysis results could be delivered in minutes or hours after specimen collection. However, these sample analysis results have little to no utility if the results are delivered days or weeks after specimen collection. Additionally, there are consumer-end-users that seek results of analysis of their bodily fluids, such as blood, to help them better understand their current wellness status.

These consumer end-users find it more desirable to have their results delivered to them as rapidly as possible after specimen collection.

### SUMMARY

Technologies are generally described that include systems and methods.

According to certain implementations, a self-operating remote lab system comprises a climate-controlled container having an interior; a plurality of ports providing conditional access to the interior for receipt and delivery of goods; a door providing conditional access to the interior; equipment in the interior and configured to receive goods and conduct analysis on the goods. The ports do not provide human entry and may include sliding doors, hinged doors, other devices for conditional access and combinations. The climate control may be provided by a system configured to control the heating, cooling, humidity, atmospheric pressure, atmospheric composition and, ventilation of the interior of the container. The port may provide conditional access via a keypad, lock, keycard system. The ports may be associated with a sensor configured to sense receipt of authorized goods. The ports may be associated with a sensor configured to sense an authorized user. The sensor may be configured to utilize radio frequency identification, near field communication, biometrics, or Bluetooth communication. The ports may be configured so a first authorized user has access to a first port and a second authorized user has access to a second port. The first user does not have access to the second port and the second user does not have access to the first port. The container may be configured to receive goods from a delivery person.

According to certain implementations, a self-operating remote lab system may include a climate-controlled, transportable container having an interior; a port providing conditional access to the interior for receipt of a specimen; a self-operating processing equipment in the interior adapted to process the specimen without support personnel being present; and a self-operating transportation system in the interior. The self-operating transportation system may link the port to the self-operating processing equipment to transport the received specimen from the port to the self-operating processing equipment for processing.

In some implementations, the self-operating remote lab system may further include a communication system configured to send results of the processing to a remote server. The self-operating processing equipment may include a preparation robot. The transportable container may be an intermodal shipping container. In some implementations, the port does not provide human entry. The climate control may be provided by a system of the container configured to control the heating, cooling, humidity, and ventilation, air pressure, and air composition of the interior of the container. The ports may provide conditional access via a sensor configured to sense receipt of authorized specimens. The port may include a first port and a second port configured so a first authorized user has access to the first port, a second authorized user has access to the second port, the first user does not have access to the second port and the second user does not have access to the first port. The self-operating remote lab system may further include a modular port adapted to connect the self-operating remote lab system to a second self-operating remote lab system. The self-operating remote lab system may further include an air delivery port adapted to receive a specimen from an aerial drone delivery. The self-operating remote lab system may include a human-accessible lab area in the interior, and an entry providing access to the human-accessible lab area.

In some implementations, a method of processing a specimen using a self-operating remote lab system, may include receiving a specimen into an interior of a climate-controlled transportable container through a port; autonomously transporting the specimen to a self-operating processing equipment in the interior; and autonomously processing the specimen using the self-operating processing equipment.

In some implementations the method further includes autonomously preparing the specimen for processing using an autonomous preparation robot. The method may further include transitioning the self-operating remote lab system from a transportation mode that improves the resilience of the self-operating remote lab system during transport to a working mode for processing specimens. The method may further include coupling the self-operating remote lab system to a second self-operating remote lab system via a modular port. The method may further include transporting the specimen or the processed specimen to the second self-operating remote lab system through the modular port. The method may further include providing results of the processing to a remote server. The method may further include providing results of the processing to a remote server includes routing a communication through a second self-operating remote lab system. The step of routing the communication through the second, self-operating remote lab system may include communicating with the second, self-operating remote lab system over an ad-hoc network. The port may be an air delivery port and the specimen may be received from an aerial drone.

In another implementation, a self-operating remote lab system includes a plurality of climate-controlled, transportable containers. Each container may include an interior; a port providing conditional access to the interior for receipt of a specimen; self-operating processing equipment in the interior adapted to process the specimen without support personnel being present; and a self-operating transportation system in the interior linking the ports to the self-operating processing equipment to transport the received specimen from the port to the self-operating processing equipment for processing. The system may further include a remote server having a processor and a memory comprising instructions that, when executed by the processor, cause the remote server to facilitate the operation of the containers.

In some implementations, the memory includes instructions that, when executed by the processor, cause the remote server to facilitate the operation of the containers using a statistical analysis approach that leverages physical consistency among the plurality of containers. The instructions that, when executed by the processor, cause the remote server to facilitate the operation of the containers using a statistical analysis approach that leverages physical consistency among the plurality of containers may further cause the remote server to: generate correlations between the plurality of containers using the physical consistency among the plurality of containers and modify a characteristic of one or more of the containers using the generated correlation.

### BRIEF DESCRIPTION OF THE DRAWINGS

FIG. 1 illustrates a block diagram of a self-operating remote lab system comprising a container, according to certain implementations.

FIG. 2 illustrates a perspective view of a system, including a plurality of cooperating self-operating remote lab systems, according to certain implementations.

FIG. 3 illustrates a system of connected containers, including independent containers and containers cooperating within a system linked across a network to a server, according to certain implementations.

FIG. 4 illustrates a process for using a self-operating remote lab system, according to certain implementations.

### DETAILED DESCRIPTION

Transportable, self-operating lab systems are provided herein. The systems may include a transportable shipping container in which a self-operating lab system resides, or the system may be spread across a plurality of cooperating containers. The systems may be configured to be as one or more modular units. When the system is provided in multiple modular units, the modular units may be communicatively coupled and, in some implementations, physically coupled. For example, the units may be designed to interact with other units. In this manner, the units may be scalable allowing for an efficient means to adjust capacity to meet market demand and have redundancy. Disclosed embodiments may be used to reduce the lag-time between specimen collection and the delivery of analysis results to the end-user. Embodiments may aid in a transition from a central or regional laboratory model to a multitude of remote, local laboratory model. This strategy can reduce cross-country shipping times from days to hours which is a significant reduction in lag-time given the specimen processing time once at a laboratory is on the order of a few hours.

The units may be configured to be readily transportable (e.g., by taking the form of a standard shipping container) and configured to be set up in various locations. These locations may include locations typically non-conducive to lab experiments, such as parking lots, disaster zones, military operations zones, research vessels, cruise-ships, naval-ships, inside buildings, inside warehouses, regions where athletic events take place (such as a running marathon, cycling event or team sporting event) and other environments. In this manner, disclosed systems may make advanced analytic platform services available to non-research organizations, such as small communities and hospitals. Further, the units may be re-locatable to, for example, meet demand. In certain implementations, the unit may be located next to and in connection with a shipping warehouse to facilitate receipt of specimens. This may be advantageous to reduce the time between specimen collection and completion of the analysis, which may be of particular use in the blood testing sector. In another example, a university or pharmaceutical development company could buy or rent a unit. Personnel from the organizations may submit specimens for processing and not need to worry about scheduling the processing. The ability to better match analysis equipment with market demand is facilitated by characteristics of intermodal containers including the relative ease and cost efficient transportability of these containers by commercially available services and hardware. This ease of unit relocation allows for better matching and reacting to market demand. In this way there is increased likelihood that expensive analysis equipment will run near capacity more often thereby increasing the duty cycle of the equipment. Furthermore, the upfront investment cost and overall operating cost is greatly reduced for customers desiring specimen analysis by transferring ownership of analysis equipment and other supporting equipment from end-users of the specimen analysis to owners of the units. In this system, equipment required for specimen analysis can be easily shared between many customers in a given locality and customers would pay a use fee. These efficiency gains and cost-sharing help make the most advanced analytical methodologies available to small, non-research communities.

Additionally, a unit may be configured to utilize robotic systems to enable the unit to receive and analyze specimens without the need for support personnel to be present. The unit may be configured to be managed remotely and request local or remote assistance as needed. Further, the units may be configured to accept specimens from typical commercial shipping providers.

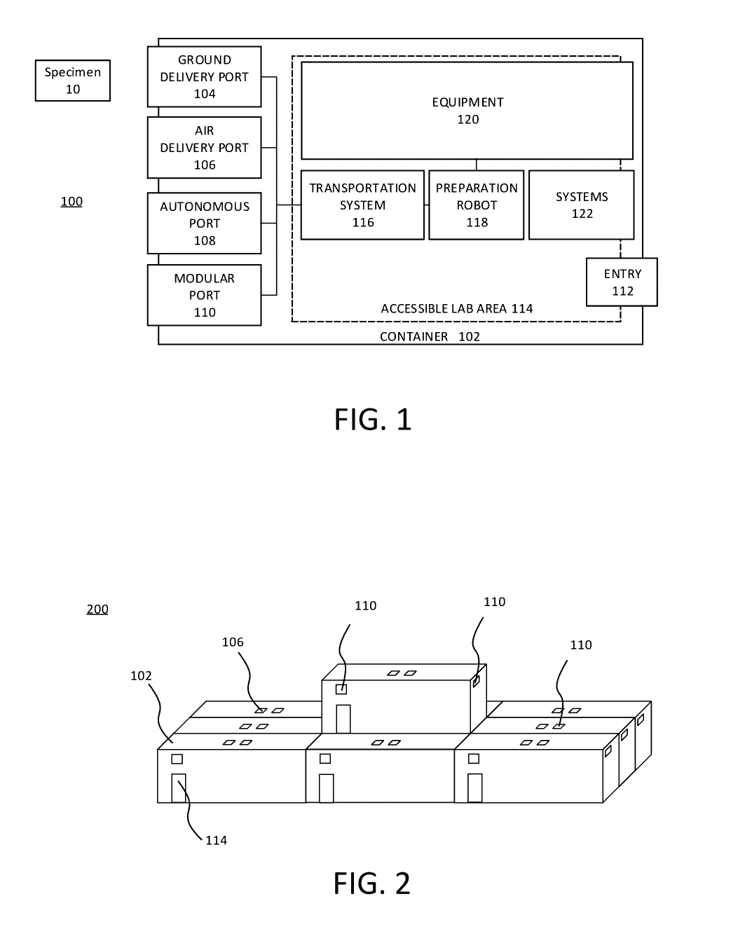

FIG. 1 illustrates a block diagram of a self-operating remote lab system 100 comprising a container 102 according to certain implementations. The container 102 comprises a ground delivery port 104, an air delivery port 106, autonomous port 108, a modular port 110, an entry 112, and an accessible lab area 114. The accessible lab area 114 may comprise a transportation system 116, a preparation robot 118, equipment 120, and systems 122.

The container 102 may be an enclosure configured to hold one or more components of the system 100. For example, in certain implementations, the container 102 may be a shipping container. The shipping container may be a standardized, reusable intermodal container constructed to various sizes (e.g., a container built to ISO standard lengths, such as 20 feet, 40 feet, 45 feet, 48 feet, and 53 feet) and configured for use as a self-operating lab system as described herein. The shipping container may include insulated walls, interior separating walls, and/or may be climate controlled as described herein.

The ports 104, 106, 108, 110 are portions of the system 100 configured to allow ingress to and egress from the container 102. For example, the ports 104, 106, 108, 110 may allow receipt of a specimen 10 into the system, such as via an opening in the container 102 and optionally may allow delivery of goods from the container 102. The ports 104, 106, 108, 110 may be configured to substantially resist entry of a person. This may be accomplished by, for example, having the opening of a port 104, 106, 108, 110 be sized or shaped such that a person cannot easily enter. The ports 104, 106, 108, 110 may also be configured to resist the entry of unauthorized or unwanted specimens 10 and resist access by unauthorized or unwanted individuals attempting to deliver or receive shipments from the ports. For example, the ports 104, 106, 108, 110 may have locking and/or shuttering systems to resist entry. Such a system may be configured to unlock or otherwise allow access upon the detection of an authorized user or specimen 10. For example, authorized specimen 10 may carry identifiers configured to authenticate the specimen 10 with the ports 104, 106, 108, 110. Such systems may include wireless communication (such as near-field communication, BLUETOOTH communication, WI-FI communication, and/or other wireless technologies), visual authentication (such as bar codes, including QR codes and/or other systems), out-of-band authentication, and other authentication systems.

The ground port 104 may be configured to receive a specimen 10 from a ground-based delivery mechanism, and in some implementations, may deliver goods such as the specimens 10 therefrom. Deliveries to the ground port 104 may include but need not be limited to mail delivery, robotic delivery, in-person delivery, and other delivery mechanisms or schemes. Shipments from the ground port 104 may include but need not be limited to mail shipments, robotic shipments, in-person shipments, and other shipment mechanisms or schemes.

The air port 106 may be configured to receive a specimen 10 from an air-based delivery mechanism, and in some implementations, the air port 106 may provide a specimen for air-based pick-up. Air transport may include but need not be limited by drone. The air port 106 and/or the container 102 may comprise various components to facilitate the transport, receipt and delivery of the specimen 10 by air, including but not limited to guidance computers or systems for communicating with drones, antennas, lights, target indicators, and other systems. The air delivery port 106 and/or the container 102 may also comprise a drone landing pad, a drone charging station, and/or a drone garage area. In certain implementations, a drone may be configured to retrieve specimens. For example, the drone may fly to a customer having a specimen, retrieve the specimen, and bring the specimen to the container 102 for processing. In another example, the drone may have or pick up a testing unit (e.g., a test strip or vessel for specimen collection), fly to a particular area (such as to a particular address, a particular person, geographic location and so on), retrieve a specimen (such as by a user depositing a biological sample or by automated means of collecting an air sample or a water sample) and return the specimen to the container 102 for processing.

The autonomous port 108 may be a port configured to receive or deliver its own specimen 10 without substantial interaction with delivery sources outside of the system 100. For example, the autonomous port 108 may contain probes or sensors configured to take biological samples from subjects proximate the autonomous port 108, may take water samples (e.g., from public water supplies sewage, rainwater, and other sources), air samples (e.g., from the atmosphere surrounding the container 102), and/or weather samples (e.g., temperature, humidity, wind speed, atmospheric pressure, atmospheric composition and/or other readings). In certain implementations, the autonomous port 108 may comprise a pneumatic tube to deliver or receive specimens.

The modular port 110 may be a port for placing the container 102 in connection with an external resource. For example, in certain implementations, the modular port 110 may be configured to enable one or more container 102 modules to communicate or otherwise interact with each other. The modular port 110 may, but need not, be configured to receive or deliver specimen 10 to other container 102 units. The modular port 110 may also be configured to connect to other kinds of systems. For example, the modular port 110 may be configured to place the container in connection with a building (e.g., a laboratory building), a vehicle (e.g., a mobile lab vehicle), or other systems. The modular port 110 and/or the container 102 may include various components to facilitate a connection, including but not limited to fastening elements, elements for fastening the container 102 to a foundation, grasping elements, coupling elements, particular connectors, physical connections, wireless connections, pneumatic tube elements, and other elements.

The entry 112 may be a door or other opening in the container configured to allow a human to enter the accessible lab area 114 of the container. The entry 112 may be secured to prevent unauthorized entry. For example, the entry 112 may be associated with a key card reader, key pad, wireless sensor, finger print scanner, retina scanner, physical lock and key, or other means for detecting authorized personnel and permitting entry.

In certain implementations, the container 102 may have a plurality of entries 112, each with its own purpose. For example, there may be an entry 112 that permits entry by shipping personnel to a shipping portion of the container 102. The shipping portion may be a part of the container where packages may be picked up or dropped off. Access to the shipping portion by the shipping entry 112 may be limited to authorized delivery personnel. As another example, the entry 112 for the accessible lab area 114 may be limited to authorized laboratory personnel and denied to shipping personnel or other users.

The accessible lab area 114 may be a region of the container 102 configured to be readily accessible by a human during a typical course of activity or use. This may be contrasted with the notion that the entirety of the container 102 may be accessible by a human after sufficient disassembly or through use of special access panels. As shown in the embodiment of the system 100 illustrated in FIG. 1, the entry 112, the transportation system 116, the preparation robot 118, the equipment 120, and the systems 122 may be at least partially connected with the accessible lab area 114 and may be accessible by a human. However, in other implementations, different regions may be made accessible or inaccessible. This may be due to space concerns, safety concerns, or due to other considerations.

The transportation system 116 may be a means for moving the specimen 10 or other objects through the system 100. For example, the transportation system 116 may facilitate transport between the ground delivery port 104, the air delivery port 106, the autonomous port 108, the modular port 110, the preparation robot 118, and/or the equipment 120. In certain implementations, the transportation system 116 may be a rail, conveyor belt, electric track vehicle system, chain conveyor, roller conveyor, pneumatic conveyor, pneumatic tube system, robotic conveyors, and other transportation systems. The transportation system 116 may be a robot configured to transfer specimens to and from adjacent containers that could be located below, above, left, right, in front, or behind the current container 102. Such a transfer may be accomplished via the transportation system 116 of a first container cooperating with a transportation system 116 of a second container.

The preparation robot 118, which can be produced by a vendor, may be a means for preparing the specimen for use by the equipment 120. For example, the preparation robot 118 may be configured to receive a delivered package containing the specimen 10, verify the integrity of the package, retrieve the specimen 10 from the package, and verify the integrity of the specimen 10. In certain implementations, the preparation robot 118 may be configured to receive, collect, or otherwise manage materials and processes necessary to perform an analysis on the specimen 10. For example, the preparation robot 118 may retrieve a specimen 10 from the transportation system 116, place the specimen 10 and necessary consumable goods in a staging area to prepare for analysis. Once the equipment 120 is ready to perform the procedure, then the preparation robot 118 may transfer or set up the specimen 10 and necessary consumable goods on the equipment 120. Once the procedure or analysis is complete, the preparation robot 118 may remove the specimen 10 from the equipment 120 and move the specimen 10 and/or a product of the analysis to another staging area. Tasks of the transportations system 116 can be performed by the preparation robot 118. Likewise, tasks of the preparation robot 118 can be performed by the transportation system 116.

The equipment 120, which can be produced by a vendor, may be equipment for carrying out one or more procedures on the specimen 10. For example, the equipment 120 may comprise systems that are vendor produced or custom built including: Agarose Gel Electrophoresis, Analytical Balance, Apoptosis Assays, Atomic Absorption Spectroscopy, Atomic Emission Spectroscopy, Atomic Force Microscopy, Autoclaving, Bacterial Cell Culture, Bio-Reactor, Bomb Calorimetry, Buffer Prep, Capillary Electrophoresis, Centrifugation, Circular Dichroism (CD), Colony Picking, Confocal Microscopy, Crossflow Filtration (TFF), Crystallization, Dialysis (Equilibrium), Dialysis (Preparative), Differential Scanning Calorimetry (DSC), Digital Droplet PCR, DNA Sequencing (Next Generation), DNA Sequencing (Sanger), DNA/RNA Synthesis, Dynamic Light Scattering (DLS), Electron Microscopy, Electroporation, Electrospray Ionization (ESI) Mass Spectrometry, Enzyme-Linked Immunosorbent Assay (ELISA), Epifluorescence Microscopy, Fast Protein Liquid Chromatography (FPLC), Flash Chromatography, Flow Chemistry, Flow Cytometry, Fluorescence Activated Cell Sorting (FACS), Fluorescence In Situ Hybridization (FISH), Fluorescence Kinetics, Fluorescence Polarization, Fluorescence Spectroscopy, Fluorescence Thermodynamics, Gas Chromatography, Genomic DNA Prep, HPLC (Ion Exchange), HPLC (Normal Phase), HPLC (Preparative), HPLC (Reverse Phase), Immunoprecipitation, Infrared Spectroscopy, Isothermal Titration Calorimetry (ITC), Light Microscopy, Liquid Handling, Liquid-Liquid Extraction, Lyophilization, MALDI Mass Spectroscopy, Melting Point Determination, Microarray Analysis, Microwave Reactions, Molecular Cloning, NMR (2D/Structural), NMR (Carbon), NMR (Proton), Organic Synthesis (Milligram to Gram Scale), Patch Clamp Recordings, Peptide Synthesis, pH Readings, Photostimulated Luminescence (PSL), Plasmid Construction, Polyacrylamide Gel Electrophoresis (PAGE), Polymerase Chain Reaction (PCR), Protein Extraction, Quantitative Real Time PCR (qPCR), Refractometry, RNA Extraction/cDNA Prep, Rotary Evaporation, Scanning Tunneling Microscopy, Solid Phase Extraction, Solubility Testing, Sonication, Speedvac Concentration, Supercritical Fluid Chromatography (SFC), Surface Plasmon Resonance (SPR), Tandem Mass Spectrometry (MS/MS), Thermometer Readings, Thin Layer Chromatography (TLC), Tissue Homogenization, Total Internal Reflection Fluorescence (TIRF) Microscopy, Total Protein Quantification, Transfection, Ultracentrifugation, UV/Vis Kinetics, UV/Vis Spectroscopy, UV/Vis Thermodynamics, Vacuum Filtration, Viral Prep, Volume Check, Western Blot, X-Ray Crystallography, Yeast Cell Culture, Blood Chemistry Analyzer and coupled analytical platforms such as a Gas Chromatography/Mass Spectrometry (GC/MS), Liquid Chromatography/Mass Spectrometry (LC/MS) and/or other systems.

The equipment 120 may also include ancillary or supporting equipment for carrying out the procedures. For example, the equipment 120 may include freezer, refrigerator, oxygen-free specimen storage areas, compressed gas cylinders, nitrogen generators, and other features for storing or otherwise maintaining the quality of the specimen 10. In certain implementations, the equipment 120 may be self-operating analytical equipment. For example, the equipment 120 may be capable of receiving, processing, and disposing of a specimen 10 without intervention by laboratory personnel. In certain implementations, the equipment 120 may be remotely operable. For example, a user may be located remotely from the equipment 120 and/or the container 102 but able to control one or more aspects of the use of the equipment 120. The transportation system 116, the preparation robot 118, and/or other support systems can perform procedures on the equipment 120 that are typically carried out by laboratory personnel but are amenable to robotic manipulation, such activities include: routine preventative maintenance, non-routine maintenance, power cycling, consumable replacing, consumable refilling, troubleshooting tasks and calibration procedures.

The systems 122 may be various systems or components to facilitate the performance of procedures within the container 102. The systems 122 may include power systems, climate-control systems, communication systems, security systems, monitoring systems, waste-disposal systems, and other systems.

The power systems may include means for connecting the container 102 to a power grid. In certain implementations, the power systems may be configured to connect to off-grid power, such as a solar power generator, a wind power generator, a battery, or other off-the-grid power systems. The container 102 may comprise the off-grid power system. In certain implementations, the power system may be configured to draw power from another container 102 (e.g. a container 102 connected via the modular port 110).

The climate-control system may be means for regulating the climate within the container 102 and/or within a portion of the container 102. For example, certain lab equipment or procedures may perform more optimally under certain conditions. The climate-control system may comprise systems for controlling the heating, cooling, humidity, atmospheric pressure, atmospheric composition, ventilation, and other aspects of climate-control. The climate-control system may also comprise filtration elements or other means for removing contaminants or maintaining proper cleanroom conditions within the container 102 or within portions of the container 102. Intra-unit and inter-unit duct work may be used to provide proper ventilation and heat dissipation for all units comprising the system.

The security system may include alarms, detectors, etc. The security system may be configured to detect and/or substantially resist unauthorized entry into the container. For example, the security system may control or be associated with the locks and/or sensors of the ports 104, 106, 108, 110 and entry 112. The security system may also be configured to resist damage, harm, or interruption to the specimens 10, equipment 120, and/or other contents of the container 102. For example, the security system may detect external hazards to the container (such as a fire or flood) and cause a change in the container 102. The change may include causing the stoppage of some or all internal analysis processes, backing up or transmitting current results or findings, placing equipment in protective configurations, and taking other precautions. The security system may also be configured to detect internal hazards, such as a spill, abnormal reaction, off gassing of materials, fire, leak, an anomalous situation, or other undesirable situation. In response, the security system may cause isolation of one or more areas of the container 102 to prevent the spread of further contamination or damage. Similarly, the security system may detect a toxic or unhealthy situation within the container 102 and prevent entry of personnel or specimens into the container 102 unless an override code is detected.

The monitoring system may be configured to monitor and record conditions inside and outside of the container 102. For example, the monitoring system may record the readings from temperature, pressure, humidity, vibration, air-quality, atmospheric composition, sound and other sensors. This information may be used for quality-control purposes. As another example, the monitoring system may include a camera system and microphone for providing a video and sound feed of conditions inside of and/or outside of the container for security, experiment monitoring, quality control/assurance, and/or other purposes.

The robotic and automated systems of the container 102 may take various forms to achieve the various goals of their function within the system. The robotic systems may include linear motion systems, multi-dimensional movement systems, arm-based movement systems, autonomous robots, etc. The various portions of the container 102 may be selected or configured to substantially withstand the forces that may be experienced during transportation. This may include anti-shock mounts for equipment. In some embodiments, one or more portions of the container 102 may be configured to be placed into a transportation mode designed to improve the resilience of the portion or components during transportation. The container or portions of it may be configured to be placed in this configuration automatically.

The waste-disposal system may include components configured to receive, process, and/or dispose of waste. For example, the waste-disposal system may include a secure location for receiving and storing waste for disposal. The transportation system 116, preparation robot 118, and/or the equipment may be configured to deposit waste in the waste-disposal system. The waste may include delivery packages, goods consumed during processing, and other waste. The waste-disposal system may include or cooperate with a port for disposal of the waste in a waste stream for removal by sanitation personnel or transportation services.

### System 200

FIG. 2 illustrates a perspective view of a system 200, including a plurality of cooperating containers 102. For example, the containers may cooperate via connections made between the modular ports 110 of the containers 102 The connection may be made via direct connection of the modular ports 110 of the containers 102, such as a wired connection or through other means of physical contact. In certain implementations, the connection may be made wirelessly, such as through WI-FI, BLUETOOTH, or other wireless communication protocols. In addition to or instead of the communication through the modular ports 110, a connection between the containers 102 may be made through air delivery ports 106 or other openings. In these cases, the containers 102 may be configured to transport goods between each other via a drone or other vehicle.

The containers 102 arranged in a cooperating system 200 may enable containers to specialize in particular forms of analysis or roles. For example, different containers 102 may be configured to perform different sample preparatory steps. Also, different containers 102 may be configured to perform different kinds of analysis. This division of functionality may enable the containers 102 to, for example, utilize particular forms of more efficient climate control or other configurations. For example, a container may be specialized to perform analysis that requires high temperatures while another container may be specialized to perform analysis that is sensitive to high temperatures. Other forms of cooperation or specialization may include containers for power generation (so the other containers need not or need not only connect to another power source), communications (such as a container having a cellular radio and a container acting as a router for communications), a container for routing received packages or deliveries (such as a container that receives external packages directly and routes the packages to other containers), a container acting as a store of supplies (such a container that is a repository of goods or resources consumed during analysis that can be distributed as needed to other containers 102), other functions, or a combination thereof.

### System 300

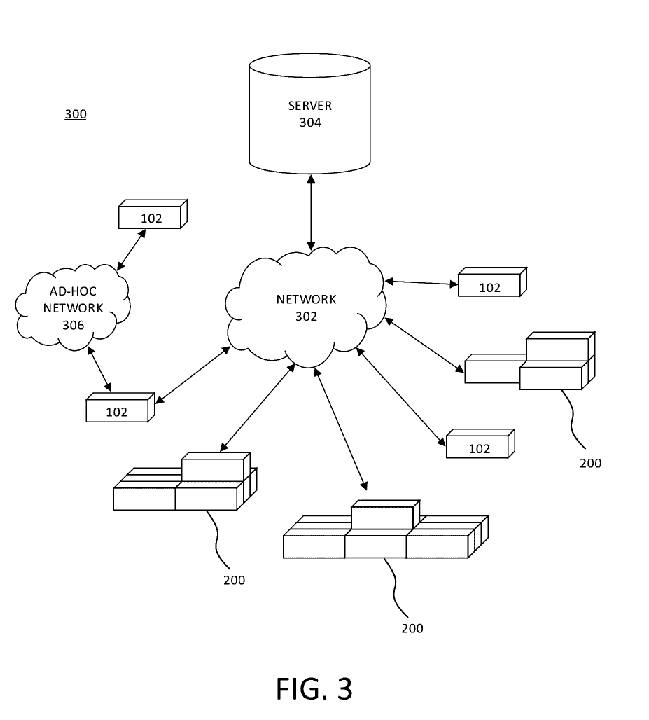

FIG. 3 illustrates a system 300 of connected containers 102, including independent containers 102 and containers 102 cooperating within a system 200 linked across a network 302 to a server 304. In addition, some containers are linked across an ad-hoc network 306. In certain implementations, the network 302 may be any means for connecting the containers 102 or systems of containers 200.

The server 304 may be a computing device that processes and executes information. The server 304 may include its own processing elements, memory components encoded with processor-executable instructions, and the like, and/or may be in communication with one or more external components (e.g., separate memory storage). The server 110 may also include one or more server computers that are interconnected via a network or separate communicating protocol. In this manner, the server 304 is programmed to provide some or all of the processes described herein, including but not limited to managing or facilitate the coordination and operation of the containers. In one embodiment, the server manages the containers 102 using a statistically-based management approach that leverages physical consistency among containers 102 (e.g., container design, equipment setup, measurement probe locations within the container, and other physical characteristics).

Individuals or computer systems located in remote areas such as a control center can manage of one or many units via connection to network 302 or 306. This control center can be in one or more locations and at each location one or more individuals or computer systems can manage one or a more containers 102. The individuals or computer systems can manage aspects of the greater system 300 and need not be limited to the management of individual components, such as a container 102. In an example, statistical analysis can be performed on any measurable characteristic of a container (e.g., container 102) or an aspect of a system of multiple containers (e.g., system 300). This statistical analysis can leverage consistency among containers to provide accurate results, which can be used to modify aspects of an analysis system, such as one or more containers or the results of analysis. Consistency among containers can allow for directly comparable measurements to be collected and analyzed. For instance, a directly comparable measurement can be a measurement of a temperature probe located in the same or substantially the same position in a plurality of containers. In this manner, a statistical calculation can be performed on, for example, the temperature within one or more of the plurality of containers, the temperature gradient between first and second ends of each container, or another characteristic. Similarly, the accuracy of the analysis equipment within one or more containers can be determined or analyzed by leveraging consistency among containers. In addition, statistical calculations may be performed on an aspect of a system of containers, such as the average temperature and humidity of the region surrounding a population of regional containers or the delivery time of specimens from a shipping hub to nearby containers. Statistical analysis, cluster analysis, principal component analysis, machine learning techniques, and other statistical or programmable approaches may be applied to the measured data in a manner that does or does not require a priori knowledge of how one measurement can relate to an aspect of the container or system of containers. This analysis may produce correlations between aspects of the system of containers and knowledge of these correlations may or may not have previously existed. These correlations may leverage the consistency among containers. One or more containers or systems of containers can respond to or be modified according to the correlations or another output of the analysis. Physical consistency among containers can allow for a high number of comparable measurements to be captured. This results in more data that can be fed into statistical analysis tools, which, in turn, can be used to find root causes of desirable or undesirable traits of containers and make the results of various containers more consistent by modifying a trait of one or more containers.

As another example, an employee or computer can manage the development and review of statistical determinations of system 300 characteristics such as the transport speed of a specimen from one container 102 to another. The employee or computer systems can use statistical analysis tools to find outliers where the specimen transport time from one container 102 to another is outside of a predetermined acceptable range, thereby triggering a corrective action. The corrective action may include deploying another container 102 to reduce transport time. Such an analysis can be extended to other aspects of system 300 including performance of subsystems 116, 118, 120, 122 of containers 120. In this way, system 300 allows for a highly statistically based management approach as the system contains a plurality of replicated individual parts (e.g., the plurality of containers 102 of the system 300 may be substantially identical to each other). A plurality of container 102 units containing equipment 120 is distinctly different than a plurality of identical analysis platforms contained in a multitude of geo-separated traditional lab spaces. Geo-separated traditional lab spaces, even those with highly controlled environments and processes, will have subtle differences that stem from human involvement and environmental variations. These differences add complexity to the statistical analysis of aspects of a traditional laboratory system. This statistical complexity reduces knowledge gained by a statistical analysis. Ultimately, this reduced knowledge makes implementation of a highly statistically based management system less likely and ultimately this reduces the overall performance of traditional laboratory systems when compared to system 300. Accordingly, embodiments disclosed herein may be relevant to overcoming shortcomings of traditional laboratory systems and provide for advanced statistical analysis.

Individuals in control centers can also perform troubleshooting tasks remotely with the aid of videofeed, microphone, transportation system 116, preparation robot 118 and other customized tools amenable to robotic manipulation.

In certain implementations, the ad-hoc network 306 may be a connection made between containers or systems of containers without connection to existing infrastructure (such as means for connecting directly to the internet). The ad-hoc network 306 may be a wireless connection between containers. It may also be accomplished through physical connection. An Internet connection may be distributed through the ad-hoc network 306. For example, a container may not have the capability to connect directly to the internet (e.g., because it lacks appropriate networking components, such as a cellular radio, because it lacks authority or permission, or the container cannot establish the connection due to a lack of signal) but can connect, through the ad-hoc 306 network, to a container that can connection to the internet and thereby share an internet connection.

The containers and systems of system 300 may cooperate in order to complete processing of specimens or other experiments. For example, one container may be tasked with analyzing certain aspects of a biological sample from a specimen, and based on the results, the specimen may be transported to a cooperating container for further analysis. In a group experiment, the system 300 may send requests to multiple containers and/or multiple subjects via the network 304 in order to collect samples from the subjects and conduct analyses.

In certain implementations, the containers may be able to initiate their own movement or transportation of specimens. For example, by sending a request to a shipping service for pick up or by having a device for the packaging and unpacking of specimens. Containers with this configuration may be able to move themselves to areas of need in the network 300 without human intervention or without significant human intervention (such as by only needing approval from a human). As another example, the containers may be able to send specimens to other containers within the system 300. For example, if an originating container has a problem or is otherwise prevented from completing a task, it may (to the extent it is able to transport the specimen) package and/or send the specimen to another container within the system 300 to finish or otherwise complete the processing.

### Example Use Case

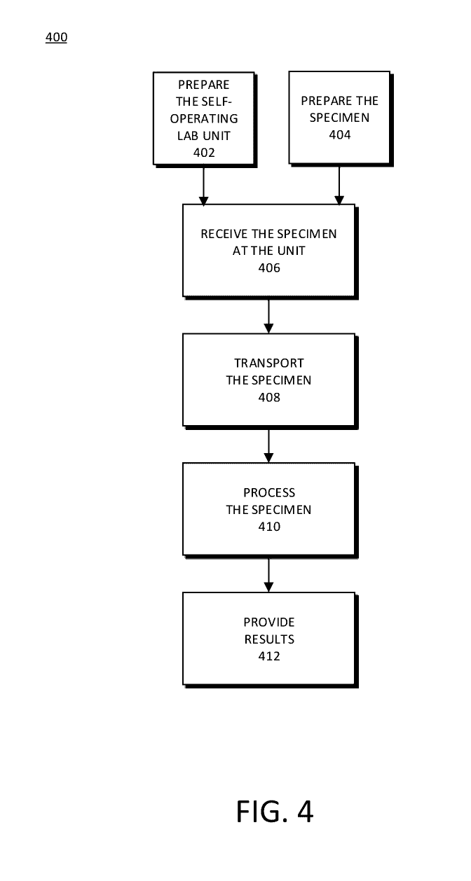

FIG. 4 illustrates an example process 400 that may be utilized in conjunction with a self-operating remote lab unit or a system of self-operating remote lab units (such as the container 102, the system 200, or the system 300). In certain implementations, the process 400 includes the steps of: preparing the unit 402, preparing a specimen 404, receiving the specimen at the unit 406, transporting the specimen 408, processing the specimen 410, and providing results 412.

The step of preparing the unit 402 may include preparing a unit (such as container 102) or a system of units (such as the system 200 or the system 300) to be used in a particular location. This may include preparing the unit for shipping to a particular location by placing the unit in a shipping configuration, transporting the unit to the particular location, and placing the unit in a usage configuration. Placing the unit in a usage configuration may comprise connecting the unit to other units via a wireless and/or a physical connection, connecting the unit to a server, connecting the unit to a desired resource (such as power, water, waste, and a stream of commerce). The climate control system and other supporting-ancillary equipment of container 102 can be configured to maintain climate control and operate supporting-ancillary equipment of the container 102 throughout the shipping process via systems 122 containing a mobile power source such as a battery, fuel cell or generator. The external power can also be supplied by a transporting vehicle itself such as semi-trailer truck, rail train or a cargo ship. The ability to maintain climate control and supporting-ancillary equipment can expedite both the preparation of the equipment 120 for shipment and the reinstatement of the equipment 120 to normal operational status. For example, in liquid chromatography/mass spectrometry applications (LC/MS), prior to shipping with traditional equipment, solvent would have to be completely removed because temperature extremes can cause solvents, such as water, to freeze causing damage to the equipment. Climate control would eliminate the need to perform this shipping-preparation work. Supporting ancillary equipment, such as a nitrogen generator, can be maintained in an operational state during transportation allowing for nitrogen gas to flow into the mass spectrometer, thereby keeping the equipment in desirable state and reducing the equipment 120 reinstatement work.

The step of preparing the specimen 404 may include steps for preparing a specimen (such as specimen 10) for use with the unit or with the rest of the process 400. In certain implementations, an example use case may begin with a customer preparing a specimen, such as by depositing a biological sample onto or into a collection device (e.g., a test strip or vessel). The specimen may be a specimen for which one or more analysis is to be conducted. The preparation of the specimen may vary depending on the type of specimen and the desired analysis.

In certain implementations, the user may receive a special package in which to place the specimen. This may be a shipping package with particular padding, compartments, or other elements to improve the shipability of the specimen without damage. The package may also include a secure element to prevent or detect unauthorized tampering with the specimen. For example, there may be a locking mechanism that is designed to be removed only by the unit. In another example, there may be a tamper-evident seal that the unit may detect or read during the analysis or receiving process. The package may be configured to transport multiple specimens, including specimens for which different processing is requested.

The package may comprise an identification element. The identification element may be an indicator that enables identification of the package and/or its contents. For example, the identification element may be a shipping label. The identification element may, but need not, be a visual indicator, such as a printed label, bar code, QR code, or other visual indicia. In certain implementations, the identification element may be an NFC element, an RFID element, a BLUETOOTH element, a secure key stored on a memory chip, or other wireless identification element.

The identification element may be configured as an authentication element. The identification element may be machine-readable such that it is able to be read by a sensor of the unit. In response to a particular identification element, the unit may unlock a port or otherwise enable receipt of the package.

In certain implementations, the identification element and the secure element may be the same element. For example, there may be a tamper-evident seal that serves as an authorization indicator that, upon opening the package, is destroyed or compromised such that it can no longer be used for authentication. For instance, if the package is opened prior to being authorized by the unit, it cannot be authorized by the unit because the element is no longer readable or the unit otherwise detects tampering.

Preparing the specimen may include interaction with a server (such as server 304). For instance, the customer may set up an account, order the package, order particular analysis, and perform other tasks. In response to receiving an order, the server may generate the identification element and/or the secure element and provide these elements to the user. In certain implementations, the server may query the capabilities of the units or systems of units. Similarly, the server may also query the availability of the units to handle the order and/or signal one or more units to prepare for the order.

In certain embodiments, the specimen may be a unit of blood. The unit of blood may be collected using a blood collection device, such as is described in U.S. Patent Publication Number 2014/0276217, entitled “Fluid sampling apparatus and method,” incorporated by reference herein for all purposes. In certain implementations, the blood collection device may be weighted on one end (such as a bottom end) so the device may be aligned to fall in a particular orientation to make the device more amenable to robotic manipulation. In another embodiment the device can contain a magnetic element, which would aid in aligning the blood collection device as it falls into a magnetic sensitive collection area.

The step of receiving the specimen at the unit 406 may include the specimen arriving at the unit. The specimen may arrive in various ways. For example, the customer may place the package in a stream of commerce to transport the package to the unit. For instance, the package may be picked up and delivered to the unit via postal mail service, such as that provided by the UNITED STATES POSTAL SERVICE. In another instance, the package may be picked up and delivered by a private transportation service (such as that provided by AMAZON, FEDEX, UPS, GOOGLE, and other organizations). The transport may be provided by a specialized service, for example so as to provide secure transit, transit with particular climate controls or for other reasons. In yet another instance, the package may be personally dropped off by the customer by visiting the unit.

While at the unit, there may be certain methods or means for authenticating, confirming, or enabling delivery. For example, the unit may be configured to receive goods through a regular stream of commerce. For example, a delivery person would not or need not have specialized training for how to deliver the specimen to the unit. The delivery may be such that the user need only authenticate with the port and deposit the goods. The authentication with the port may be as simple as the unit detecting that one or more of the goods and the specimen are authorized. For example, the package or specimen may contain a unit-detectable identifier that unlocks or authenticates the port, thus allowing the port to receive the goods. In another example, the unit may detect that the user is authorized. This may be achieved through various means such as biometrics, keycard authentication, near field communication, radio-frequency identification, keyed access, and/or other means. Requiring both an authorized user and authorized goods may be used to satisfy chain of title, security, or other concerns with the remote and automated nature of the process.

The settings and requirements of the unit may be configured in various ways. For example, the unit may be configured to reject the delivery of otherwise allowable specimens if there are one or more flags. The flags may include: the specimen is too old, the specimen was not transported properly (e.g., delivery is being attempted by an unauthorized user or a sensor in the package alerts the unit that transportation was at an improper temperature or received an improper level of force), the unit does not allow the requested analysis, and other flags. In certain embodiments, the flag may cause the specimens to be accepted but given special treatment. For example, if the flag indicates that the specimens are about to expire, the specimens may be given expedited processing. If the specimens are expired, then they may be accepted and disposed of or otherwise segregated from other portions of the unit. In other embodiments, the flag might be a characteristic of the specimen such as viscosity of a blood sample or other physical or chemical properties of the specimen itself. The average temperature or other environmental conditions that the specimen experienced during the specimen collection and transportation are other examples of specimen characteristics that would be flags for the unit to consider. The unit may prepare or analyze the specimen in a unique manner using these flags. These specimen characteristics can be measured within the unit or measured outside the unit. Specimen characteristics can be communicated to the unit via a remote server.

Various conditions of the specimens and the unit may be collected and transmitted to a server for further reprocessing and/or display to a user. For example, the unit may transmit a message to the server indicating the status of the specimens. This may include when the specimens have been received, what analysis is being conducted, an estimated process completion time, flags on the specimens, and other indicators. Users may be provided with a dashboard via a website that allows them to view the status of a particular specimen and perform various actions, such as, canceling processing, and requesting different processing.

Upon receipt of the specimen, the unit may perform various verification steps. These may be performed prior to completion of receipt of the specimen (e.g., before the port opens to accept the package), after partial receipt of the specimen (e.g., while within an “airlock” or other segregated portion of the unit), after complete receipt of the specimen (e.g., when the specimen is wholly within the unit), and/or combinations thereof.

Verification performed after partial receipt of the specimen may include verification within an “airlock” or other segregated portion of the unit. This may be useful for determining the integrity of the package and/or the specimen in order to resist contamination of the interior of the unit. This may include weighing the specimen and comparing the weight with an expected weight, visual inspection of the specimen and/or the package.

The step of transporting the specimen 408 may include moving the specimen 10 through the unit or through a system of units. For example, the specimen 10 may be moved from a port to equipment for processing, analysis or for other actions. In certain implementations, the transportation system 116 may move the specimen 10 through the unit.

The step of processing the specimen 410 may include using equipment (such as equipment 120) to process, analyze, dispose of, or otherwise act on the specimen. This may include analysis within a single container or analysis that cooperates with multiple containers. In certain implementations, the analysis may be conducted without or substantially without human intervention in the process. For example, the equipment may be automated or robotic equipment.

An example of processing a specimen includes the analysis of dried blood spots by LC/MS methodologies. In this process two types of vendor provided platforms are used. The first type of platform is a specimen preparation robot (e.g., preparation robot 118). As a specific example, this platform may be the PAL-RTC produced by CTC ANALYTICS, Industriestrasse 20, 4222 Zwingen, Switzerland. The PAL-RTC platform may be adapted as generally described in U.S. Patent Publication Number 2014/0276217, entitled “Fluid sampling apparatus and method,” and previously incorporated by reference. The platform may take a raw dried-blood-spot specimen and prepare it for LC/MS analysis without any local human intervention, provided that the specimens were loaded into the platform, consumables were maintained at a desirable state by transport system 116, and someone or a computer system managed the software based controls of the platform. After the dried-blood-spot specimen is prepared for LC/MS analysis, the transportation system 116 can deliver the prepared-specimen to the LC/MS platform. For example, the LC/MS platform may be a WATERS ACQUITY UPLC coupled to a WATERS XEVO G2-XS QTof mass spectrometer produced by WATERS CORPORATION of 34 Maple Street, Milford, Mass. 01757, USA. This LC/MS platform is an example of equipment 120 and can analyze the prepared dried-blood-spot specimen without any local human intervention (e.g., provided that the specimens were loaded into the platform, consumables were maintained at a desirable state and someone or a computer system managed the software based controls of the platform). A recent advance that WATERS released for WATERS mass spectrometers is IONKEY column technology. This IONKEY column format makes replacing “columns” (a consumable used in LC/MS applications) a task that could be automated by robotic systems such as those described here in transportation system 116. The two specific instrument platforms mentioned here are single examples among many platforms that are available.

In certain embodiments, the specimen may be processed by a first piece of equipment within a first unit, the specimen 10 and/or a product of the processing by the first piece of equipment may be transported to or otherwise used by a second piece of equipment within a second unit to perform additional processing. The analysis of the specimen may be performed entirely within the unit or distributed across various locations. For example, initial data collection may be performed in the unit, which then transmits the data to a server, another unit, or another location for further processing or data analysis. Post-analysis data processing of the raw data into processed data or processed data into a result can be performed by computers contained in equipment 120, within systems 122, networked server 304 or other equipment.

The step of providing results 412 may include providing a deliverable to a customer. This may include, for example, sending a digital representation of the results to the customer via email, a web portal, mobile application, or other means. In certain implementations, a physical good may be sent to the user or other location. For example, the product of processing the specimen by the equipment may be sent. In another example, a printout or other representation of the results may be sent to the customer. In these instances, a portion of the unit or another unit of a system of units may package and ship the physical good to the desired location. This may include, providing the physical good to the ground delivery port for pickup by the customer or a delivery person.

While the methods disclosed herein have been described and shown with reference to particular operations performed in a particular order, it will be understood that these operations may be combined, sub-divided, or re-ordered to form equivalent methods without departing from the teachings of the present disclosure. Accordingly, unless specifically indicated herein, the order and grouping of the operations should not be construed as limiting.

Similarly, it should be appreciated that in the foregoing description of example embodiments, various features are sometimes grouped together in a single embodiment, figure, or description thereof for the purpose of streamlining the disclosure and aiding in the understanding of one or more of the various aspects. These methods of disclosure, however, are not to be interpreted as reflecting an intention that the claims require more features than are expressly recited in each claim. Rather, as the following claims reflect, inventive aspects lie in less than all features of a single foregoing disclosed embodiment, and each embodiment described herein may contain more than one inventive feature.

While the present disclosure has been particularly shown and described with reference to embodiments thereof, it will be understood by those skilled in the art that various other changes in the form and details may be made without departing from the spirit and scope of the disclosure.

What is claimed is:

1. A self-operating remote lab system comprising:
a climate-controlled, transportable container having an interior;
a port providing conditional access to the interior for receipt of a specimen;
self-operating processing equipment in the interior adapted to process the specimen without support personnel being present; and
a self-operating transportation system in the interior linking the port to the self-operating processing equipment to transport the received specimen from the port to the self-operating processing equipment for processing.

2. The self-operating remote lab system of claim 1, further comprising a communication system configured to send results of the processing to a remote server.

3. The self-operating remote lab system of claim 1, wherein the self-operating processing equipment comprises a preparation robot.

4. The self-operating remote lab system of claim 1, wherein the transportable container is an intermodal shipping container.

5. The self-operating remote lab system of claim 1, wherein the port provides conditional access via a sensor configured to sense receipt of authorized specimens;
wherein the port does not provide human entry; and
wherein the self-operating remote lab system further comprises a human-accessible lab area in the interior, and an entry providing access to the human-accessible lab area.

6. The self-operating remote lab system of claim 1, wherein the climate control is provided by a system of the container configured to control the heating, cooling, humidity, ventilation, air pressure, and air composition of the interior of the container.

7. The self-operating remote lab system of claim 1, wherein the port comprises a first port and a second port configured so a first authorized user has access to the first port, a second authorized user has access to the second port, the first user does not have access to the second port and the second user does not have access to the first port.

8. The self-operating remote lab system of claim 1, further comprising a modular port adapted to connect the self-operating remote lab system to a second self-operating remote lab system.

9. The self-operating remote lab system of claim 1, further comprising an air delivery port adapted to receive a specimen from an aerial drone delivery.

10. A method of processing a specimen using a self-operating remote lab system, the method comprising:
receiving a specimen into an interior of a climate-controlled transportable container through a port;
autonomously transporting the specimen to a self-operating processing equipment in the interior; and
autonomously processing the specimen using the self-operating processing equipment.

11. The method of claim 10, further comprising autonomously preparing the specimen for processing using an autonomous preparation robot.

12. The method of claim 10, further comprising transitioning the self-operating remote lab system from a transportation mode that improves the resilience of the self-operating remote lab system during transport to a working mode for processing specimens.

13. The method of claim 10, further comprising coupling the self-operating remote lab system to a second self-operating remote lab system via a modular port.

14. The method of claim 13, further comprising transporting the specimen or the processed specimen to the second self-operating remote lab system through the modular port.

15. The method of claim 10, further comprising providing results of the processing to a remote server.

16. The method of claim 15, wherein the step of providing results of the processing to a remote server comprises routing a communication through a second self-operating remote lab system using an ad-hoc network.

17. The method of claim 10, wherein the port is an air delivery port and the specimen is received from an aerial drone.

18. A self-operating remote lab system comprising:
a plurality of climate-controlled, transportable containers, each container having:
an interior;
a port providing conditional access to the interior for receipt of a specimen;
self-operating processing equipment in the interior adapted to process the specimen without support personnel being present; and
a self-operating transportation system in the interior linking the ports to the self-operating processing equipment to transport the received specimen from the port to the self-operating processing equipment for processing;
a remote server having a processor and a memory comprising instructions that, when executed by the processor, cause the remote server to facilitate the operation of the containers.

19. The self-operating remote lab system of claim 18, wherein the memory comprises instructions that, when executed by the processor, cause the remote server to facilitate the operation of the containers using a statistical analysis approach that leverages physical consistency among the plurality of containers.

20. The self-operating remote lab system of claim 19, wherein the instructions that, when executed by the processor, cause the remote server to facilitate the operation of the containers using a statistical analysis approach that leverages physical consistency among the plurality of containers further cause the remote server to:
generate correlations between the plurality of containers using the physical consistency among the plurality of containers; and
modify a characteristic of one or more of the containers using the generated correlation.
